(19) United States
(12) Patent Application Publication
(10) Pub. No.: US 2023/0224639 A1
(43) Pub. Date: Jul. 13, 2023

(54) PERSONALIZED AUDIO ZONE VIA A COMBINATION OF ULTRASONIC TRANSDUCERS AND LOW-FREQUENCY SPEAKER

(71) Applicant: Analog Devices, Inc., Wilmington, MA (US)

(72) Inventors: Boris LERNER, Sharon, MA (US); Gina G. AQUILANO, Somerville, MA (US)

(73) Assignee: Analog Devices, Inc., Wilmington, MA (US)

(21) Appl. No.: 18/068,244

(22) Filed: Dec. 19, 2022

Related U.S. Application Data
(60) Provisional application No. 63/297,326, filed on Jan. 7, 2022.

(51) Int. Cl. H04R 3/12; G10K 11/175

(52) U.S. Cl. CPC H04R 3/12; G10K 11/175

(57) ABSTRACT

Systems, devices, and methods related to audio systems for providing personalized audio zones are provided. An example audio system includes a first speaker to transmit an ultrasonic signal modulated by a first portion of a first audio signal. The audio system further includes a second speaker to transmit a second portion of the first audio signal, where the second portion is in a lower frequency band than the first portion. The audio system further includes a noise canceller to at least attenuate a second audio signal, where the second audio signal is in a lower frequency band than the first portion of the first audio signal.

### CROSS REFERENCE TO RELATED APPLICATIONS

The present application claims priority to and the benefit of the U.S. Provisional Patent Application No. 63/297,326 entitled “PERSONALIZED AUDIO ZONE VIA A COMBINATION OF ULTRASONIC TRANSDUCERS AND LOW-FREQUENCY SPEAKER” and filed Jan. 7, 2022, which is hereby incorporated by reference in its entirety as if fully set forth below and for all applicable purposes.

### TECHNICAL FIELD OF THE DISCLOSURE

The present disclosure generally relates to audio systems, and, more specifically, to providing personalized audio zones using a combination of ultrasonic transducer(s) and low-frequency speaker(s).

### BACKGROUND

Audio industry has been working on a solution for providing personalized audio zones. The concept of a personal audio zone is to have sound playback locally restricted such that, ideally, adjacent regions of an indoor or outdoor space can exhibit their own individual audio content without interfering with each other. This may enable users to listen to their content of choice without disturbing others next to them, yet, without any headphones. One use case scenario may be for audio streaming within a vehicle, where different occupants (e.g., a driver and/or passengers) in a vehicle may listen to different audio streams without interfering with each other. Other potential areas of application for personal audio may include information and advertisement audio feed in commercial facilities, guiding and narration in museums and exhibitions, office space personalization, and entertainment audio systems.

While directional speakers may be used to direct audio playback in a certain direction, providing personalized audio zones in an open space with a high sound quality can be challenging.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a block diagram illustrating an exemplary audio system providing personalized audio zones, according to some embodiments of the disclosure;

FIG. 1B is a block diagram illustrating an exemplary ultrasonic audio subsystem, according to some embodiments of the disclosure;

FIG. 2 is a block diagram illustrating an exemplary vehicle including an audio system providing personalized audio zones, according to some embodiments of the disclosure; and

FIG. 3 is a flow diagram illustrating an exemplary method for providing a personalized audio zone, according to some embodiments of the present disclosure.

### DESCRIPTION OF EXAMPLE EMBODIMENTS OF THE DISCLOSURE

Overview

The systems, methods and devices of this disclosure each have several innovative embodiments, no single one of which is solely responsible for all of the desirable attributes disclosed herein. Details of one or more implementations of the subject matter described in this specification are set forth in the description below and the accompanying drawings.

Various techniques have been proposed to solve the problem of providing personalized audio zones, but most approaches are unable to provide a high sound quality (e.g., for music playback). In one approach, audio cancellation may be used, where a cancellation speaker can be placed near each listener to cancel audio that is intended for other listeners. However, unlike audio headphone applications, the transfer function between the cancellation speaker and the listener's ears does not remain fixed. For instance, the transfer function may vary with movements of the listener's head. The variation in the transfer function can be drastic, where in some instances, the cancellation may be completely off (e.g., providing no cancellation), especially at higher frequencies where small head movements can correspond to large phase changes in the audio signals. While cameras may be used to monitor head movements of the listener and the cancellation speaker may utilize adaptive signal processing techniques to adjust the cancellation based on the detected head movements, such designs can be overly complicated and costly.

In another approach, audio re-enforcement may be used, where an array of speakers may be configured to beamform audio to create a large contrast in sound levels between the audio for the intended listener and audio for the unintended listener. Various levels of success have been achieved using this approach, but the separation (between the intended audio and the unintended audio) may be at most about 20 decibels (dBs), which may not be sufficient to create non-interfering audio zones.

In yet another approach, ultrasonically modulated audio is used, where an audio signal may be carried by (e.g., modulated onto) an ultrasonic signal. Ultrasonic frequencies may refer to frequencies of 20 kilohertz (kHz) or higher, which are inaudible to humans. Ultrasonic signals are laser beam directional, and thus may be beamed towards the intended listener's ears. The ultrasonic signal may be demodulated near the intended listener's ears, for example, by beaming a separate demodulating ultrasonic sine wave towards the listener's ears or by letting a non-linearity of the signal to hit the listener's ears to demodulate it. While ultrasonic signal can provide a good audio separation between an intended listener and an unintended listener, lower-frequency audio reproduced from audio-encoded ultrasonic signal may appear to be “thin” (e.g., with insufficient bass components) without increasing the ultrasound power, for example, beyond a safe limit for humans. Accordingly, there is a need to improve techniques for providing personalized audio zones.

The present disclosure provides mechanisms for providing personalized audio zones by utilizing a combination of ultrasonic speaker(s) and separate lower-frequency speaker(s). In one aspect, an audio system for providing a personalized audio zone may include a first speaker to transmit an ultrasonic signal modulated by a high-frequency portion (e.g., a first portion) of a first audio signal and a second speaker to transmit a low-frequency portion (e.g., a second portion) of the first audio signal. The first audio signal may be intended for a first listener. The first speaker may be an ultrasonic speaker (which may be highly directional), and the second speaker may be a standard low-frequency speaker such as a woofer (which is non-directional). The first and second speakers may be placed nearby the first listener. In a similar way, the audio system may provide another personalized audio zone to a second listener (e.g., in an area adjacent to the first listener) using a directional ultrasonic speaker to transmit a high-frequency portion of an audio signal (intended for the second listener) and a non-directional low-frequency speaker to transmit a low-frequency portion of the audio signal. Because low-frequency audio is transmitted using non-directional speakers, low-frequency audio intended for the first listener and low-frequency audio intended for the second listener can interfere with each other.

To avoid the interference at the low frequency, the audio system may further include an acoustic noise canceller to at least attenuate a second audio signal (the low-frequency portion of the audio signal intended for the second listener), for example, in a frequency band at least partially overlapping in frequency with the low-frequency portion of the first audio signal (intended for the first listener). To that end, the acoustic noise canceller may include a microphone, a processing element coupled to the microphone, and a third speaker coupled to the processing element. The microphone may receive the second audio signal. The processing element may generate an anti-phase audio signal based on the second audio signal. The third speaker may also be placed nearby the first listener and may transmit the anti-phase audio signal such that the second audio signal may be cancelled locally in the personalized audio zone of the first listener. Consequently, the first listener may listen to a combined audio signal including the high-frequency portion and the low-frequency portion (intended for the first listener) and with no interference or at least a reduced interference from the second audio signal (intended for the second listener).

The systems, schemes, and mechanisms described herein advantageously provide personalized audio zones with high-quality audio in the high frequency range as well as in the low frequency range. For example, audio in the high frequency range and audio in the low frequency range may have comparable sound levels. Further, intended audio in a personalize zone and unintended audio in the personalized zone may have a separation of more than 20 dB (e.g., about 30 dB or more). While the disclosed embodiments may be discussed in the context of providing personalized audio zones in vehicles, the disclosed techniques are suitable for use in any open space and/or closed space. For example, the disclosed embodiments can be used to provide personalized audio zones for information and advertisement audio feed in commercial facilities, guiding and narration in museums and exhibitions, office space personalization, and entertainment audio systems

Example Audio Systems Providing Personalized Audio Zones

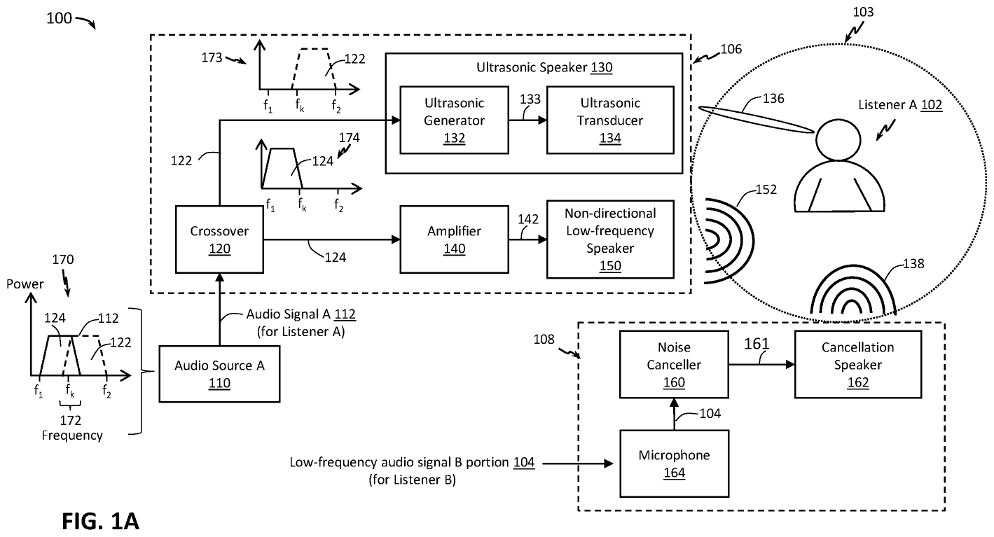

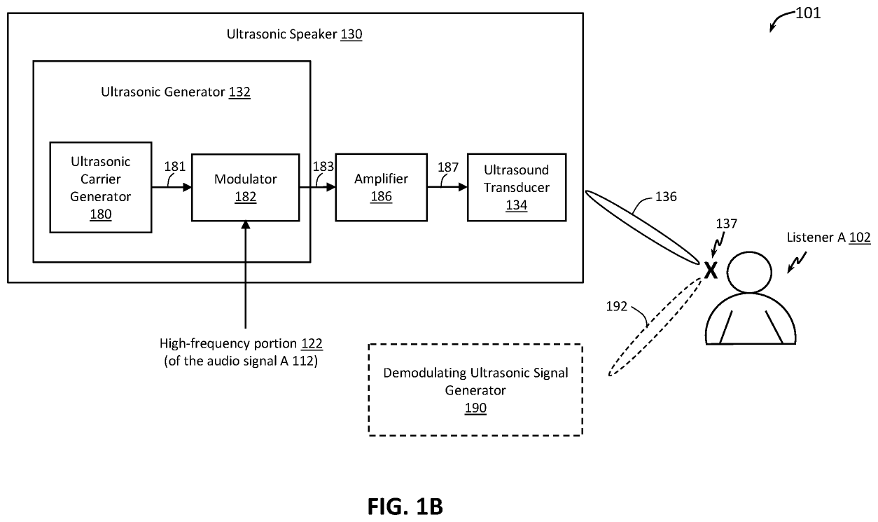

FIG. 1A is a block diagram illustrating an exemplary audio system 100 providing personalized audio zones, according to some embodiments of the disclosure. The audio system 100 may provide a plurality of personalized audio zones to various listeners within a closed space or an open space. In some embodiments, the audio system 100 may provide a plurality of personalized audio zones in a vehicle, for example, one for each occupant in the vehicle. As shown in FIG. 1A, the system 100 may include an audio source A 110, an audio playback subsystem 106, and an acoustic noise cancellation subsystem 108. The audio playback subsystem 106 may include a crossover device 120, an ultrasonic speaker 130, an amplifier 140, and a non-directional low-frequency speaker 150. The acoustic noise cancellation subsystem 108 may include a noise canceller 160, a cancellation speaker 162, and a microphone 164. Each of the blocks/components/modules in the audio playback subsystem 106 and the acoustic noise cancellation subsystem 108 may be implemented using a combination of hardware and/or software. Further, each of the blocks/components/modules in the audio playback subsystem 106 and the acoustic noise cancellation subsystem 108 may be implemented as a separate physical unit or module or combined into a single unit or multiple units.

The audio system 100 may provide a personalized audio zone 103 to a listener A 102. For instance, the audio source A 110 may stream an audio signal A 112 (e.g., a first audio signal) to the listener A 102. The audio signal A 112 may include any audio content such as music, audio books, news, navigational instructions, etc.

The crossover device 120 may be coupled to the audio source A 110. The crossover device 120 may be an electronic device that receives a single input audio signal (e.g., the audio signal A 112) and creates two or three output signals of separating frequency bands (e.g., a high-frequency band, a mid-frequency band, and a low-frequency band). In some instances, the crossover device 120 may include various filters configured to filter the input audio signal according to the desired separating frequency bands. In the illustrated example of FIG. 1A, the crossover device 120 divides the audio signal A 112 into a high-frequency portion 122 (e.g., a first portion) and a low-frequency portion 124 (e.g., a second portion). For instance, the crossover device 120 may include a high-pass filter to generate the high-frequency portion 122 from the audio signal A 112 and a low-pass filter to generate the low-frequency portion 124 from the audio signal A 112. As an example, the audio signal A 112 may be in a frequency range between f₁ and f₂, the high-frequency portion 122 may be in a frequency range between about fₖ and f₂, and the low-frequency portion 124 may be in a frequency range between f₁ and about fₖ. The power spectrum of the audio signal A 112 including the high-frequency portion 122 and the low-frequency portion 124 are shown by 170 (where the x-axis represents frequency and the y-axis represents power). In some instances, the high-frequency portion 122 and the low-frequency portion 124 can be partially overlapping in frequencies (as shown by 172), for example, depending on the roll-offs of the filters at the crossover device 120. In general, the filters may have any suitable frequency responses (or roll-offs). The power spectrum for the high-frequency portion 122 and the low-frequency portion 124 are also separately shown by 173 and 174, respectively.

The audio playback subsystem 106 may transmit the high-frequency portion 122 using the ultrasonic speaker 130 (which is highly directional) and transmit the low-frequency portion 124 using the non-directional low-frequency speaker 150 (e.g., a standard speaker or a woofer). The ultrasonic speaker 130 and the non-directional low-frequency speaker 150 may be placed in proximity to the intended listener A 102. In some instances, the ultrasonic speaker 130 and the non-directional low-frequency speaker 150 can be placed nearby the listener A 102's ears. The ultrasonic speaker 130 may include an ultrasonic generator 132 and one or more ultrasound transducers 134 (e.g., an array of ultrasound 2, 3, 4, 5, 6, 7, 8 or more transducers).

The ultrasonic speaker 130 may be coupled to the crossover device 120 to receive the high-frequency portion 122 of the audio signal A 112. The ultrasonic generator 132 may modulate the high-frequency portion 122 onto an ultrasonic carrier signal (e.g., at a frequency of 20 kHz or higher). The modulated signal 133 (e.g., an electrical signal) may be provided to the ultrasound transducers 134. The ultrasound transducers 134 may convert the electrical signal into an ultrasonic beam 136 (which is inaudible to human) directed towards the listener A 102. In some embodiments, the ultrasound transducers 134 may be made of a piezoelectric material. A more detailed view of the ultrasonic speaker 130 is discussed below with reference to FIG. 1B.

FIG. 1B is a block diagram illustrating an exemplary ultrasonic audio subsystem 101, according to some embodiments of the disclosure. The ultrasonic audio subsystem 101 may correspond to the high-frequency audio playback portion (e.g., the ultrasonic portion) of the audio playback subsystem 106 of FIG. 1. As shown, the ultrasonic audio subsystem 101 may include an ultrasonic speaker 130 including an ultrasonic generator 132, an amplifier 186, and ultrasound transducers 134. Each of the ultrasonic generator 132 and amplifier 186 may be implemented using a combination of hardware and/or software. Further, the ultrasonic generator 132, the amplifier 186, and the ultrasound transducers 134 can be implemented as separate circuitries or integrated as a single integrated circuit. In general, the ultrasonic generator 132, the amplifier 186, and the ultrasound transducers 134 can be arranged in any suitable configuration. Further still, in some instances, the ultrasonic speaker 130 can include a controller or processor configured to control and/or configure the operations of the ultrasonic generator 132, the amplifier 186, and the ultrasound transducers 134.

The ultrasonic speaker 130 may include an ultrasonic carrier generator 180 and a modulator 182. The ultrasonic carrier generator 180 may generate a carrier signal 181 in an ultrasonic frequency band (at 20 kHz or higher). The modulator 182 may modulate the high-frequency portion 122 of the audio signal A 112 onto the ultrasonic carrier signal 181. The amplifier 186 may be coupled to the ultrasonic generator 132 and may include electronics that amplifies the amplitudes of the modulated ultrasound signal 183. The ultrasound transducers 134 may convert the amplified ultrasound signal 187 into an ultrasonic beam 136. For instance, the ultrasound transducers 134 may be an ultrasound transducer array configured to generate the ultrasonic beam 136 focused in the direction of the listener A 102, for example, using beamforming or beam steering. As shown, the ultrasonic beam 136 is directed (or beamformed) towards a focal point 137 (shown by the symbol “X”) next to the listener A 102. In some embodiments, the ultrasonic speaker 130 may include a controller or a digital signal processor to control the ultrasound transducers 134 for beamforming.

In an embodiment, the ultrasonic audio subsystem 101 may optionally include a demodulating ultrasonic signal generator 190 to generate a demodulating ultrasonic beam 192 directing towards the listener A 102 (e.g., at the focal point 137). For instance, the demodulating ultrasonic signal generator 190 may generate an ultrasonic signal (e.g., an electrical signal) and may include ultrasound transducers similar to the ultrasound transducers 134 to convert the electrical signal into the ultrasonic beam 192. At the focal point 137, the ultrasonic beam 136 (carrying the high-frequency portion 122 of the audio signal A 112) is mixed (or interact) with the demodulating ultrasonic beam 192, causing a demodulation to occur in which the high-frequency portion 122 is reproduced (as an audio signal in the frequency band between fₖ and f₂).

In other embodiments, the ultrasonic audio subsystem 101 may not include the demodulating ultrasonic signal generator 190. In such embodiments, a self-demodulation may occur when the ultrasonic beam 136 (carrying the high-frequency portion 122 of the audio signal A 112) is collided with an obstruction (e.g., the listener A 102's ears) in which the high-frequency portion 122 is reproduced.

Returning back to FIG. 1A, the amplifier 140 may be coupled to the crossover device 120 to receive the low-frequency portion 124 of the audio signal A 112. The amplifier 140 may amplify the amplitudes of the low-frequency portion 124. The non-directional low-frequency speaker 150 may be coupled to the amplifier 140 and may transmit the amplified low-frequency signal 142 as non-directional sound waves 152. The non-directional low-frequency speaker 150 may be a regular or standard speaker, for example, including a single, moving electromagnetic coil and cone to create sound waves from an electrical signal (e.g., the low-frequency portion 124 of the audio signal A 112). In some embodiments, the non-directional low-frequency speaker 150 may be a woofer (e.g., producing sounds from about 50 Hz to about 1 kHz).

While not shown in FIG. 1A, the system 100 may provide another personalized audio zone to another listener B (e.g., in an area or zone adjacent to the personalized audio zone 103 of the listener A 102) using similar mechanisms. For instance, the audio system 100 may utilize a directional ultrasonic speaker similar to the ultrasonic speaker 130 to transmit a high-frequency portion of an audio signal B to the listener B and a non-directional low-frequency speaker similar to the non-directional low-frequency speaker 150 to transmit a low-frequency portion of the audio signal B. Because low-frequency audio is transmitted using non-directional speakers, low-frequency audio intended for the listener A 102 and low-frequency audio intended for the listener B can interfere with each other.

To avoid the interference at the low frequency, the acoustic noise cancellation subsystem 108 may cancel the low-frequency portion 104 (e.g., a second audio signal) of the audio signal B intended for the listener B. The microphone 164 may pick up or receive the low-frequency portion 104 of the audio signal B (intended for the listener B). The noise canceller 160 may be coupled to the microphone 164 and may receive the low-frequency portion 104 of the audio signal B (or at least a portion of the low-frequency portion 104). The noise canceller 160 may generate an anti-phase signal 161 based on the low-frequency portion 104 of the audio signal B. The anti-phase signal 161 may have a substantially opposite phase than the low-frequency portion 104 and a substantially equal amplitude as the low-frequency portion 104 such that the anti-phase signal 161 may cancel the low-frequency portion 104 of the audio signal B or at least reduce an amplitude of the low-frequency portion 104 of the audio signal B in the personalized audio zone 103 of the listener A 102. In some embodiments, the noise canceller 160 may include an adaptive filter with weights (e.g., filter coefficients) updated using a least mean square (LMS) algorithm or any suitable error minimization algorithm to provide the anti-phase signal 161. In some embodiments, the audio system 100 may have knowledge of the audio source for the unintended listener B, and thus may utilize the prior knowledge of the audio source for the unintended listener B to enhance the noise cancellation. In some embodiments, the noise canceller 160 may be implemented by a digital signal processor or any suitable processor. In some embodiments, the noise canceller 160 may be implemented via a combination of hardware and/or software. The cancellation speaker 162 (e.g., a woofer) may be coupled to the noise canceller 160 and may playback the anti-phase signal 161 as sound waves 138. The cancellation speaker 162 may be placed nearby the listener A 102 (e.g., next to the listener A 102's ears to provide local cancellation in the personalized audio zone 103) so that the listener A 102 may not hear the low-frequency portion 104 of the audio signal B intended for the listener B. That is, the listener A 102 may hear a combined signal including the high-frequency portion 122 (reproduced based on a demodulation of the ultrasonic beam 136) and the low-frequency portion 124 (from the sound waves 152), but without the low-frequency portion 104 of the audio signal B intended for the listener B. In other words, the personalized audio zone 103 is created for the listener A 103.

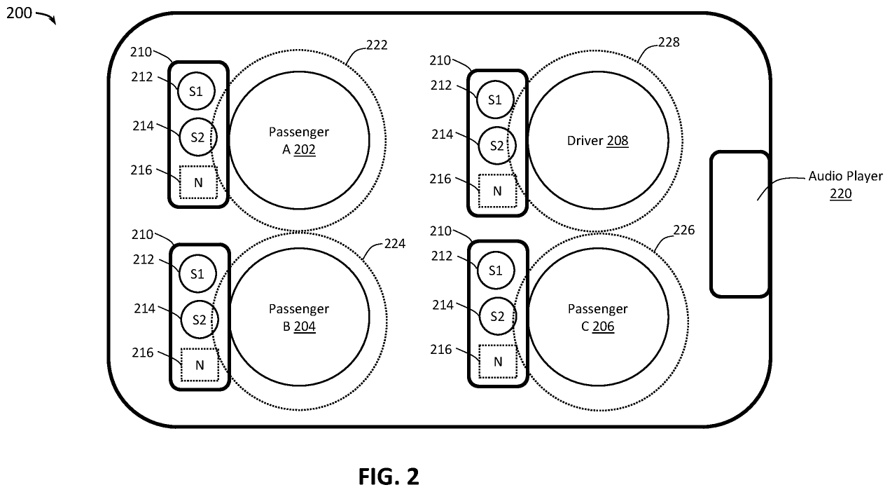

FIG. 2 is a block diagram illustrating an exemplary vehicle 200 including an audio system providing personalized audio zones, according to some embodiments of the disclosure. As shown, the vehicle 200 may include an audio player 220 and car seats 210. The vehicle 200 may provide a separate personalize audio zone to each occupant in each car seat 210 using similar mechanisms as the audio system 100 discussed above with reference to FIGS. 1A and 1B. In the illustrated example of FIG. 2, the audio system in the vehicle 200 may provide a personalized audio zone 222 to a passenger A 202, a personalized audio zone 224 to a passenger B 204, a personalized audio zone 226 to a passenger C 206, and a personalized audio zone 228 to a driver 208. In general, there may be any suitable number of personalized audio zones (e.g., 2, 3, 4, 5, 6 or more) in a vehicle.

The audio player 220 may stream various audio contents (e.g., music, audio books, news, navigational instructions, etc.) to various occupants. In particular, the audio player 220 may stream separate audio content for each occupant (e.g., the passenger A 202, the passenger B 204, the passenger C 206, and the driver 208) at the vehicle 200. For each occupant, the audio system may include a first speaker S1 212 for transmitting a high-frequency portion (e.g., the high-frequency portion 122) of an audio signal (e.g., the audio signal A 112) intended for the corresponding occupant, and a second speaker S2 214 for transmitting a low-frequency portion (e.g., the low-frequency portion 124) of the audio signal. The first speaker S1 212 and the second speaker S2 214 may be coupled to the audio player 220. The first speaker S1 212 and the second speaker S2 214 may be installed or arranged on the car seat 210 in which the corresponding occupant is located. In some embodiments, the first speaker S1 212 and the second speaker S2 214 may be within the headrest of the car seat 210 so that the first speaker S1 212 and the second speaker S2 214 may be nearby (in proximity to) the corresponding listener A 102's ears.

In one embodiment, the first speaker S1 212 and the second speaker S2 214 may be similar to the ultrasonic speaker 130 and the non-directional low-frequency speaker 150, respectively, as discussed above with reference to FIGS. 1A and 1B. Because low-frequency audio is transmitted using non-directional speakers, the audio system may further include an acoustic noise canceller N 216 similar to the acoustic noise cancellation subsystem 108 discussed above with reference to FIG. 1A for each occupant in the vehicle 200. As shown, an acoustic noise canceller N 216 may be arranged or installed at each car seat 210 (e.g., at the headrest) for cancelling low-frequency audio that are intended for occupants other than the occupant situated at the car seat 210.

While FIG. 2 illustrates the first speaker S1 212, the second speaker S2 214, and the acoustic noise canceller N 216 (if present) to be arranged in a certain order in each car seat 210, the first speaker S1 212, the second speaker S2 214, and the acoustic noise canceller N 216 (if present) can be arranged in any suitable configuration.

Example Methods for Providing Personalized Audio Zones

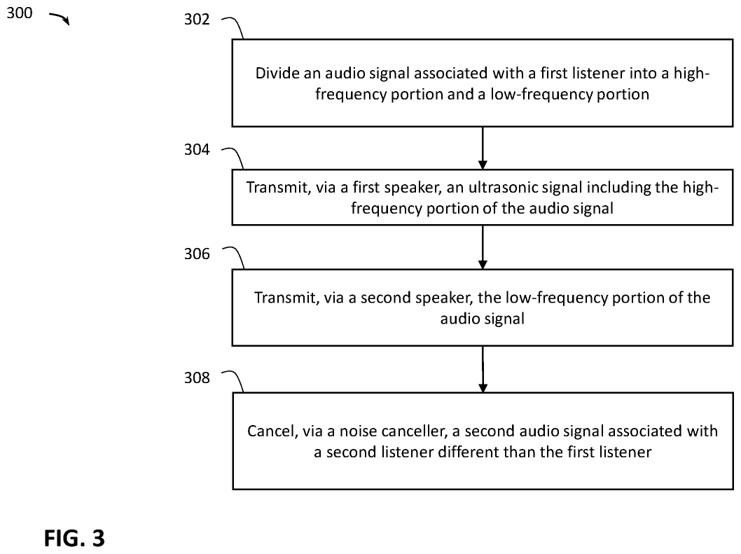

FIG. 3 is a flow diagram illustrating an exemplary method 300 for providing a personalized audio zone, according to some embodiments of the present disclosure. The method 300 can be implemented by the audio system 100. Although the operations of the method 300 may be illustrated with reference to particular embodiments of the audio system 100 disclosed herein, the method 300 may be performed using any suitable hardware components and/or software components. Operations are illustrated once each and in a particular order in FIG. 3, but the operations may be performed in parallel, reordered, and/or repeated as desired.

At 302, a first audio signal associated with a first listener is divided into a high-frequency portion and a low-frequency portion. In some embodiments, the first audio signal may correspond to the audio signal A 112, the high-frequency portion may correspond to the high-frequency portion 122, and the low-frequency portion may correspond to the low-frequency portion 124. In some embodiments, means for performing the operations of 302 may include a crossover device similar to the crossover device 120 as discussed above with reference to FIG. 1A.

At 304, an ultrasonic signal including the high-frequency portion of the first audio signal is transmitted via a first speaker. In some embodiments, the first speaker may correspond to the ultrasonic speaker 130 as discussed above with reference to FIGS. 1A, 1B, and 2 and/or the speaker S1 212 as discussed above with reference to FIG. 2.

At 306, the low-frequency portion of the first audio signal is transmitted via a second speaker. In some embodiments, the second speaker may correspond to the non-directional low-frequency speaker 150 as discussed above with reference to FIG. 1A and/or the speaker S2 214 as discussed above with reference to FIG. 2.

At 308, a second audio signal associated with a second listener different than the first listener is cancelled via a noise canceller. In some embodiments, means for performing the operations of 308 may include an acoustic noise cancellation subsystem similar to the acoustic noise cancellation subsystem 108 as discussed above with reference to FIG. 1A and/or the acoustic noise canceller N 216 as discussed above with reference to FIG. 2.

### Examples

Example 1 includes an audio system for providing a personalized audio zone, the audio system including a first speaker to transmit an ultrasonic signal modulated by a first portion of a first audio signal; a second speaker to transmit a second portion of the first audio signal, where the second portion is in a lower frequency band than the first portion; and a noise canceller to at least attenuate a second audio signal, where the second audio signal is in a lower frequency band than the first portion of the first audio signal.

In Example 2, the audio system of example 1 can optionally include where the first speaker is an ultrasonic directional speaker, and where the second speaker is a non-directional speaker.

In Example 3, the audio system of any of examples 1-2 can optionally include where the second speaker is a low-frequency speaker.

In Example 4, the audio system of any of examples 1-3 can optionally include where the first audio signal is associated with a first listener, and the second audio signal is associated with a second listener different from the first listener.

In Example 5, the audio system of example 4 can optionally include where the second portion of the first audio signal associated with the first listener is in a first frequency band, and the second audio signal associated with the second listener is in a second frequency band at least partially overlapping with the first frequency band.

In Example 6, the audio system of any of examples 1-5 can optionally include where the noise canceller includes a microphone to receive the second audio signal; a processing element coupled to the microphone, the processing element to generate an anti-phase audio signal based on the second audio signal; and a third speaker coupled to the processing element, the third speaker to transmit the anti-phase audio signal.

In Example 7, the audio system of any of examples 1-6 can optionally include a crossover device to divide the first audio signal into the first portion and the second portion.

In Example 8, the audio system of any of examples 1-7 can optionally include where the first speaker includes an ultrasonic generator to generate the ultrasonic signal by modulating an ultrasonic carrier signal by the first portion of the first audio signal.

In Example 9, the audio system of any of examples 1-8 can optionally include where the ultrasonic signal is directed towards a focal point, and where the audio system further includes an ultrasonic speaker to transmit a demodulating ultrasonic signal directing towards the focal point.

Example 10 includes a vehicle, including an audio system configured to create personalized audio zones in the vehicle, the audio system including an audio player to stream a first audio signal for a first listener in the vehicle and a second audio signal for a second listener in the vehicle; a first speaker to transmit an ultrasonic signal modulated by a first portion of the first audio signal; a second speaker to transmit a second portion of the first audio signal, where the second portion is in a lower frequency band than the first portion; and a noise canceller to at least attenuate a portion of the second audio signal, where the portion of the second audio signal is in a lower frequency band than the first portion of the first audio signal.

In Example 11, the vehicle of example 10 can optionally include a seat, where at least one of the first speaker, the second speaker, or the noise canceller is mounted on a headrest of the seat.

In Example 12, the vehicle of any of examples 10-11 can optionally include where the first speaker is an ultrasonic directional speaker, and where the second speaker is a non-directional speaker.

In Example 13, the vehicle of any of examples 10-12 can optionally include where the second speaker is a low-frequency speaker.

In Example 14, the vehicle of any of examples 10-13 can optionally include where the second portion of the first audio signal is in a first frequency band, and the portion of the second audio signal is in a second frequency band at least partially overlapping with the first frequency band.

In Example 15, the vehicle of any of examples 10-14 can optionally include where the noise canceller includes a microphone to receive the portion of the second audio signal; a processing element coupled to the microphone, the processing element to generate an anti-phase audio signal based on the portion of the second audio signal; and a third speaker coupled to the processing element, the third speaker to transmit the anti-phase audio signal.

In Example 16, the vehicle of any of examples 10-15 can optionally include where the audio system further includes a crossover device to divide the first audio signal into the first portion and the second portion.

In Example 17, the vehicle of any of examples 10-16 can optionally include where the first speaker includes an ultrasonic generator to generate the ultrasonic signal by modulating an ultrasonic carrier signal by the first portion of the first audio signal.

Example 18 includes a method for providing a personal audio zone, the method including dividing a first audio signal associated with a first listener into a high-frequency portion and a low-frequency portion; transmitting, via a first speaker, an ultrasonic signal including the high-frequency portion of the first audio signal; transmitting, via a second speaker, the low-frequency portion of the first audio signal; and cancelling, via a noise canceller, a second audio signal associated with a second listener different than the first listener, where the second audio signal and the low-frequency portion of the first audio signal are at least partially overlapping in frequency.

In Example 19, the method of example 18 can optionally include where the first speaker is an ultrasonic directional speaker, and where the second speaker is a low-frequency speaker.

In Example 20, the method of any of examples 18-19 can optionally include where the cancelling the second audio signal includes generating an anti-phase audio signal based on the second audio signal; and transmitting, via a third speaker, the anti-phase audio signal.

Variations and Implementations

While embodiments of the present disclosure were described above with references to exemplary implementations as shown in FIGS. 1A, 1B, 2-3, a person skilled in the art will realize that the various teachings described above are applicable to a large variety of other implementations.

In certain contexts, the features discussed herein can be applicable to automotive systems, safety-critical industrial applications, medical systems, scientific instrumentation, wireless and wired communications, radio, radar, industrial process control, audio and video equipment, current sensing, instrumentation (which can be highly precise), and other digital-processing-based systems.

In the discussions of the embodiments above, components of a system, such as amplifiers, filters, speakers, and/or other components can readily be replaced, substituted, or otherwise modified in order to accommodate particular circuitry needs. Moreover, it should be noted that the use of complementary electronic devices, hardware, software, etc., offer an equally viable option for implementing the teachings of the present disclosure related to audio systems, in various communication systems.

Parts of various systems for implementing audio systems as proposed herein can include electronic circuitry to perform the functions described herein. In some cases, one or more parts of the system can be provided by a processor specially configured for carrying out the functions described herein. For instance, the processor may include one or more application specific components, or may include programmable logic gates which are configured to carry out the functions describe herein. The circuitry can operate in analog domain, digital domain, or in a mixed-signal domain. In some instances, the processor may be configured to carrying out the functions described herein by executing one or more instructions stored on a non-transitory computer-readable storage medium.

In one example embodiment, any number of blocks or components of the present figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of DSPs, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

In another example embodiment, the blocks or components of the present figures may be implemented as stand-alone modules (e.g., a device with associated components and circuitry configured to perform a specific application or function) or implemented as plug-in modules into application specific hardware of electronic devices. Note that particular embodiments of the present disclosure may be readily included in a system on chip (SOC) package, either in part, or in whole. An SOC represents an IC that integrates components of a computer or other electronic system into a single chip. It may contain digital, analog, mixed-signal, and often RF functions: all of which may be provided on a single chip substrate. Other embodiments may include a multi-chip-module (MCM), with a plurality of separate ICs located within a single electronic package and configured to interact closely with each other through the electronic package.

It is also imperative to note that all of the specifications, dimensions, and relationships outlined herein (e.g., the number of components of audio systems shown in FIGS. 1A and 1B) have only been offered for purposes of example and teaching only. Such information may be varied considerably without departing from the spirit of the present disclosure, or the scope of the appended claims. It should be appreciated that the system can be consolidated in any suitable manner. Along similar design alternatives, any of the illustrated circuits, components, modules, and elements of the present figures may be combined in various possible configurations, all of which are clearly within the broad scope of this specification. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Various aspects of the illustrative embodiments are described using terms commonly employed by those skilled in the art to convey the substance of their work to others skilled in the art. For example, the term “connected” means a direct electrical connection between the things that are connected, without any intermediary devices/components, while the term “coupled” means either a direct electrical connection between the things that are connected, or an indirect connection through one or more passive or active intermediary devices/components. In another example, the term “circuit” means one or more passive and/or active components that are arranged to cooperate with one another to provide a desired function. Also, as used herein, the terms “substantially,” “approximately,” “about,” etc., may be used to generally refer to being within +/−20% of a target value, e.g., within +/−10% of a target value, based on the context of a particular value as described herein or as known in the art.

Numerous other changes, substitutions, variations, alterations, and modifications may be ascertained to one skilled in the art and it is intended that the present disclosure encompass all such changes, substitutions, variations, alterations, and modifications as falling within the scope of the examples and appended claims. Note that all optional features of the apparatus described above may also be implemented with respect to the method or process described herein and specifics in the examples may be used anywhere in one or more embodiments.

1. An audio system for providing a personalized audio zone, the audio system comprising:
a first speaker to transmit an ultrasonic signal modulated by a first portion of a first audio signal;
a second speaker to transmit a second portion of the first audio signal, wherein the second portion is in a lower frequency band than the first portion; and
a noise canceller to at least attenuate a second audio signal, wherein the second audio signal is in a lower frequency band than the first portion of the first audio signal.

2. The audio system of claim 1, wherein the first speaker is an ultrasonic directional speaker, and wherein the second speaker is a non-directional speaker.

3. The audio system of claim 1, wherein the second speaker is a low-frequency speaker.

4. The audio system of claim 1, wherein:
the first audio signal is associated with a first listener, and
the second audio signal is associated with a second listener different from the first listener.

5. The audio system of claim 4, wherein:
the second portion of the first audio signal associated with the first listener is in a first frequency band,
the second audio signal associated with the second listener is in a second frequency band at least partially overlapping with the first frequency band.

6. The audio system of claim 1, wherein the noise canceller comprises:
a microphone to receive the second audio signal;
a processing element coupled to the microphone, the processing element to generate an anti-phase audio signal based on the second audio signal; and
a third speaker coupled to the processing element, the third speaker to transmit the anti-phase audio signal.

7. The audio system of claim 1, further comprising:
a crossover device to divide the first audio signal into the first portion and the second portion.

8. The audio system of claim 1, wherein the first speaker comprises:
an ultrasonic generator to generate the ultrasonic signal by modulating an ultrasonic carrier signal by the first portion of the first audio signal.

9. The audio system of claim 1, wherein the ultrasonic signal is directed towards a focal point, and wherein the audio system further comprises:
an ultrasonic speaker to transmit a demodulating ultrasonic signal directing towards the focal point.

10. A vehicle, comprising:
an audio system configured to create personalized audio zones in the vehicle, the audio system comprising:
an audio player to stream a first audio signal for a first listener in the vehicle and a second audio signal for a second listener in the vehicle;
a first speaker to transmit an ultrasonic signal modulated by a first portion of the first audio signal;
a second speaker to transmit a second portion of the first audio signal, wherein the second portion is in a lower frequency band than the first portion; and
a noise canceller to at least attenuate a portion of the second audio signal, wherein the portion of the second audio signal is in a lower frequency band than the first portion of the first audio signal.

11. The vehicle of claim 10, further comprising:
a seat, wherein at least one of the first speaker, the second speaker, or the noise canceller is mounted on a headrest of the seat.

12. The vehicle of claim 10, wherein the first speaker is an ultrasonic directional speaker, and wherein the second speaker is a non-directional speaker.

13. The vehicle of claim 10, wherein the second speaker is a low-frequency speaker.

14. The vehicle of claim 10, wherein:
the second portion of the first audio signal is in a first frequency band, and
the portion of the second audio signal is in a second frequency band at least partially overlapping with the first frequency band.

15. The vehicle of claim 10, wherein the noise canceller comprises:
a microphone to receive the portion of the second audio signal;
a processing element coupled to the microphone, the processing element to generate an anti-phase audio signal based on the portion of the second audio signal; and
a third speaker coupled to the processing element, the third speaker to transmit the anti-phase audio signal.

16. The vehicle of claim 10, wherein the audio system further comprises:
a crossover device to divide the first audio signal into the first portion and the second portion.

17. The vehicle of claim 10, wherein the first speaker comprises:
an ultrasonic generator to generate the ultrasonic signal by modulating an ultrasonic carrier signal by the first portion of the first audio signal.

18. A method for providing a personal audio zone, the method comprising:
dividing a first audio signal associated with a first listener into a high-frequency portion and a low-frequency portion;
transmitting, via a first speaker, an ultrasonic signal including the high-frequency portion of the first audio signal;
transmitting, via a second speaker, the low-frequency portion of the first audio signal; and
cancelling, via a noise canceller, a second audio signal associated with a second listener different than the first listener, wherein the second audio signal and the low-frequency portion of the first audio signal are at least partially overlapping in frequency.

19. The method of claim 18, wherein the first speaker is an ultrasonic directional speaker, and wherein the second speaker is a low-frequency speaker.

20. The method of claim 18, wherein the cancelling the second audio signal comprises:
generating an anti-phase audio signal based on the second audio signal; and
transmitting, via a third speaker, the anti-phase audio signal.
